(19) United States
(12) Patent Application Publication
(10) Pub. No.: US 2004/0240495 A1
(43) Pub. Date: Dec. 2, 2004

(54) Laser light output apparatus, image display apparatus, and semiconductor laser driving control method

(75) Inventor: Naoki Akamatsu, Kumagaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/830,018

(22) Filed: Apr. 23, 2004

(30) Foreign Application Priority Data
May 30, 2003 (JP) 2003-155466

(51) Int. Cl. H01S 3/13

(52) U.S. Cl. 372/32

(57) ABSTRACT

A laser light output apparatus comprises a semiconductor laser which has a suitable operating temperature, a driving section which supplies a driving current to the semiconductor laser, a temperature sensing section which senses the temperature of the semiconductor laser, an electronic temperature control section which controls the temperature of the semiconductor laser to the suitable operating temperature on the basis of the temperature sensed by the temperature sensing section in a state where at least the semiconductor laser is being driven, and a driving current control section which sets the driving current to an initial value smaller than a steady value at the suitable operating temperature at the start time of the driving of the semiconductor laser and changes the driving current to the steady value as the temperature of the semiconductor laser changes to the suitable operating temperature under the control of the electronic temperature control section.

### CROSS-REFERENCE TO RELATED APPLICATIONS

This application is based upon and claims the benefit of priority from prior Japanese Patent Application No. 2003-155466, filed May 30, 2003, the entire contents of which are incorporated herein by reference.

### BACKGROUND OF THE INVENTION

1. Field of the Invention

This invention relates to a laser light output apparatus used in, for example, an image display apparatus, such as a projection display, an image display apparatus including the laser light output apparatus, and a method of controlling the driving of the semiconductor laser.

2. Description of the Related Art

A semiconductor laser is used as a light source for an optical transmission unit installed in, for example, a station for an optical communication system. Jpn. Pat. Appln. KOKOKU Publication No. 8-021747 (hereinafter, referred to as reference 1) has disclosed an optical transmission apparatus which uses a semiconductor laser for this type of application.

Generally, a semiconductor laser has a suitable operating temperature. According to reference 1, the suitable operating temperature is in the range of 0° C. to 60° C. The optical transmission apparatus written in the reference detects the temperature of a semi-conductor laser 10 by means of a thermistor 18 and, when the temperature condition has exceeded the temperature range, heats or cools the semiconductor laser by means of a heat absorbing and generating unit 19. This configuration not only causes the operating temperature range of the semiconductor laser 10 to expand up to the range of, for example, −40° C. to 85° C. but also reduces the power consumption of the heat absorbing and generating unit 19.

In recent years, a semiconductor laser has been attracted as a light source for an image display apparatus, such as a projection display. Since image display apparatuses of this type are often provided as household appliances, they are expected to be placed in a severer environment than optical transmission apparatuses for the use of vendors. Specifically, since an image display apparatus is often placed in front of the wall or corner of a room, the heat generated inside the apparatus is difficult to dissipate, with the result that the temperature in the housing is liable to rise. This tendency is particularly noticeable in high-temperature seasons and areas. In a closed room or a poor ventilated place, the internal temperature may rise significantly and exceed the suitable operating temperature of the semiconductor laser. Therefore, it is necessary to take some measures to cause the semiconductor laser to operate at a suitable temperature.

Unlike an optical transmission apparatus expected to operate continuously, an image display apparatus is expected to have its power supply turned on and off relatively often. In the technique written in reference 1, as soon as the temperature of the semiconductor laser has exceeded the specified range, the heat absorbing and generating unit is operated. Therefore, to manage the temperature of the semi-conductor laser in the image display apparatus by the technique written in reference 1, electric power is supplied to the cooling element and others even when the power supply is off, with the result that electric power is consumed wastefully. That is, the image display apparatus is at a disadvantage in that the consumption of standby power is high.

To avoid the disadvantage, if the operation of the cooling element is stopped when the power supply is off, the temperature of the semiconductor laser will naturally rise. In this state, if the power supply is turned on again, it is possible that full-power driving current will be injected into the semiconductor laser outside the specified temperature range. As is well known, the higher the temperature of the junction is or the larger the injection current is, the more the semiconductor laser deteriorates and therefore the shorter its service life becomes. This should by all means be avoided particularly in an apparatus placed in a high-temperature environment.

As described above, the conventional technique is at a disadvantage that the heat absorbing and generating unit consumes electric power even in the standby state. In addition, there is a possibility that the semiconductor laser will be driven at full power in a high-temperature environment, which leads to the disadvantage of hastening the deterioration of the semiconductor laser. That is, with the conventional semiconductor-laser temperature management method, it is difficult to make the reduction of the consumption of standby power compatible with the prevention of the shortening of the service life of the semiconductor laser in apparatuses whose power supply is turned on and off frequently, such as household appliances.

### BRIEF SUMMARY OF THE INVENTION

According to an aspect of the present invention, there is provided a laser light output apparatus includes a semiconductor laser which has a suitable operating temperature; a driving section which supplies a driving current to the semiconductor laser; a temperature sensing section which senses the temperature of the semiconductor laser; an electronic temperature control section which controls the temperature of the semiconductor laser to the suitable operating temperature on the basis of the temperature sensed by the temperature sensing section in a state where at least the semiconductor laser is being driven; and a driving current control section which sets the driving current to an initial value smaller than a steady value at the suitable operating temperature at the start time of the driving of the semiconductor laser and changes the driving current to the steady value as the temperature of the semiconductor laser changes to the suitable operating temperature under the control of the electronic temperature control section.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a functional block diagram of an embodiment of an image display apparatus according to the present invention;

FIG. 2 is a detailed block diagram of the important part of the image display apparatus 68 in FIG. 1;

FIG. 3 is a fictional block diagram of a first embodiment of a laser light output apparatus according to the present invention;

FIG. 4 is a graph showing the relationship between the supplied current and the temperature from the start time of the driving of the laser light output apparatus in FIG. 3;

FIG. 5 is a graph showing the relationship between the heat generated and the driving current in the semiconductor laser 101;

FIG. 6 is a flowchart to help explain the procedure for the operation of the laser light output apparatus of FIG. 3;

FIG. 7 is a functional block diagram of a second embodiment of a laser light output apparatus according to the present invention;

FIG. 8 is a functional block diagram of a third embodiment of a laser light output apparatus according to the present invention;

FIG. 9 is a timing chart to help explain the procedure for the operation of the laser light output apparatus of FIG. 8; and

FIG. 10 is a flowchart to help explain another procedure for the operation of the laser light output apparatus of the invention.

### DETAILED DESCRIPTION OF THE INVENTION

Hereinafter, referring to the accompanying drawings, embodiments of the present invention will be explained in detail.

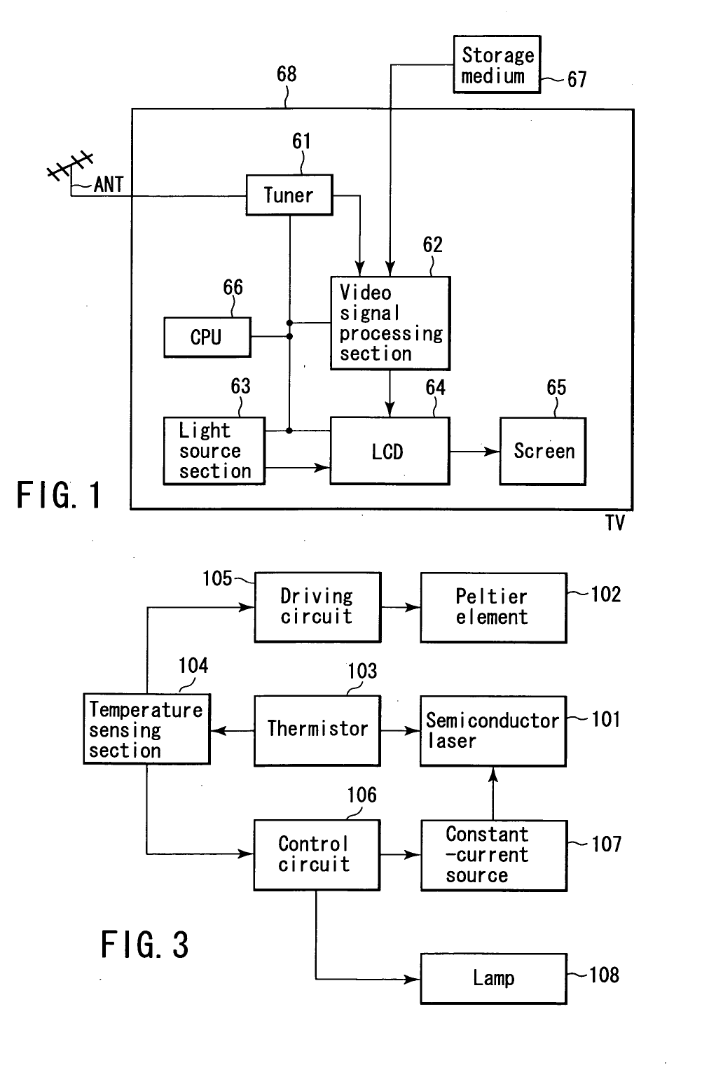

FIG. 1 is a functional block diagram of an embodiment of an image display apparatus according to the present invention. The image display apparatus 68 of FIG. 1 is realized as, for example, a projection display. In FIG. 1, radio waves arriving at an antenna ANT are demodulated by a tuner 61, which produces a video signal. The video signal and a video signal read from a storage medium 67, such as a DVD (Digital Versatile Disk) medium, are inputted to a video signal processing section 62. The video signal processing section 62 selects the video signal from either the tuner 61 or storage medium 67, subjects the selected video signal to processes, including Y/C separation, color demodulation, and sequential scanning conversion, and outputs the resulting signal to a liquid-crystal display section (LCD) 64.

A light source section 63 generates and outputs high-power laser light. The laser light is caused to enter an LCD, is subjected to spatial modulation by the LCD on the basis of the video signal inputted from the video signal processing section 62, and then is projected onto a screen 65. Control of various operations of the tuner 61, video signal processing section 62, light source section 63, and LCD 64 is performed by a CPU (Central Processing Unit) 66.

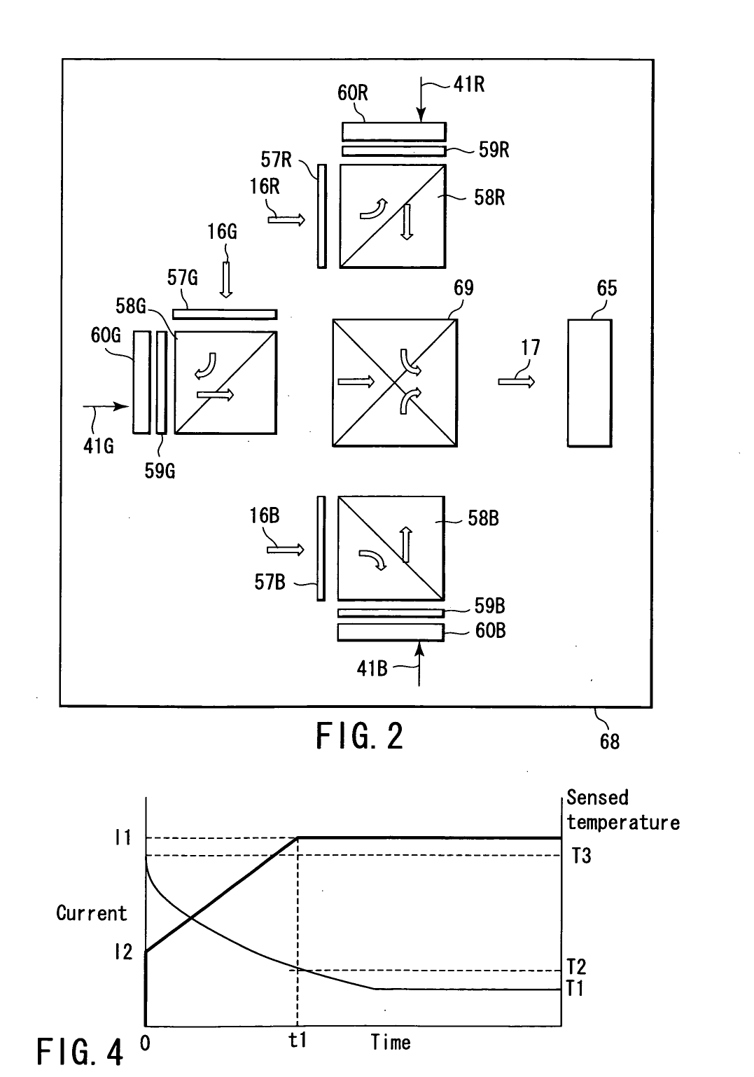

FIG. 2 is a detailed block diagram of the important part of the image display apparatus 68 in FIG. 1. The image display apparatus 68 generates a projection image to the screen 65 for each of the three primary colors, R (Red), G (Green), and B (Blue). For example, in the case of R (red), red laser light 16R generated by the laser light output apparatus (not shown) is caused to enter a polarization beam splitter 58R and is reflected by the splitter 58R via a polarizing plate 57R. The path of the red laser light 16R is changed to a reflective liquid-crystal display unit 60R. A red video signal 41R is inputted to the reflective liquid-crystal unit 60R. The laser light 16R is subjected to spatial modulation according to the video signal 41R and is reflected. The reflected laser light passes through a ¼ wavelength plate 59R and then the polarization beam splitter 58R and is inputted to a synthetic prism 69.

Similarly, green laser light 16G passes through a polarizing plate 57G and a polarization beam splitter 58G and is caused to enter a reflective liquid-crystal display unit 60G. The entered laser light is subjected to spatial modulation according to a green video signal 41G and is reflected. The reflected laser light passes through a ¼ wavelength plate 59G and then the polarization beam splitter 58G and is inputted to the synthetic prism 69. Blue laser light 16B passes through a polarizing plate 57B and a polarization beam splitter 58B and is caused to enter a reflective liquid-crystal display unit 60B. The entered laser light is subjected to spatial modulation according to a blue video signal 41B and is reflected. The reflected laser light passes through a ¼ wavelength plate 59B and then the polarization beam splitter 58B and is inputted to the synthetic prism 69. The synthetic prism 69 combines the respective special modulation lights to produce projection light 17 and projects the projection light onto the screen 65. As a result, a color image is formed on the screen 65.

(First Embodiment)

FIG. 3 is a fictional block diagram of a first embodiment of a laser light output apparatus according to the present invention. In FIG. 3, the output light from a semiconductor laser 101 passes through a coupled circuit (not shown) and is caused to enter an optical-fiber. A Peltier element 102 and a thermistor 103 provided to the element are mounted near the semiconductor laser 101. The resistance value of the thermistor 103 changes greatly according to the temperature.

The characteristic of the thermistor is expressed by the following expression using constant B of the thermistor (e.g., B=3450 K), provided that the resistance value at room temperature (25° C.=298 K) is R25=10 kΩ. That is, the resistance value R (T) of the thermistor 103 at a given absolute temperature of T is expressed by the following equation (1):

R(T)=R25−exp{B(1/T−1/298)} (1)

A temperature sensing section 104 senses the temperature of the semiconductor laser 101 on the basis of the resistance value R(T). The temperature sensing section 104 supplies to a driving circuit 105 a signal corresponding to the difference between the resistance value R(T) and the resistance value R(T1) corresponding to a specific temperature of T1(e.g., 25° C.). The driving circuit 105 causes a driving current to flow into the Peltier element 102 according to the inputted signal. As a result, the temperature of the semi-conductor laser 101 is feedback-controlled to the specific temperature T1.

On the other hand, the temperature sensing 104 supplies the sensed temperature to a control circuit 106. When the supplied sensed temperature is equal to or higher than T2=30° C., the upper limit of the operating temperature range, the control circuit 106 goes into a current reduction specified state. The control circuit 106 controls a constant-current source 107, depending on whether it is in the current reduction specified state. That is, when not in the current reduction specified state, the control circuit 106 controls the constant-current source 107 so that a steady-current value 11 may be supplied to the semiconductor laser 101 for specific operation. When in the current reduction specified state, the control circuit 106 controls the constant-current source 107 so that current 12 smaller than current value 11 and equal to or larger than the threshold value may flow into the semiconductor laser 101.

When the control circuit 106 goes into the current reduction specified state, this state is reflected on a lamp 108. That is, the lamp 108 is turned on, which informs the user that the semiconductor laser 101 is being driven with a driving current smaller than a steady-state value.

FIG. 4 is a graph showing the relationship between the supplied current (bold solid line) and the temperature (thin sold line) from the start time of the driving of the laser light output apparatus in FIG. 3. When the power supply of the laser light output apparatus is turned on at time 0 in FIG. 4, the thermistor 103, temperature sensing section 104, and control circuit 106 start to operate. In this state, suppose the temperature sensing section 104 has sensed temperature T3 equal to or higher than the operating temperature range upper limit T2. Then, according to the sensed temperature sent from the temperature sensing section 104, the control circuit 106 goes into a current decreased state. The control circuit 106 immediately controls the constant-current source 107 so that a start current 12 smaller than the steady current value 11 and equal to or larger than the threshold value may flow into the semiconductor laser 101. Therefore, at this point in time, the output of light is started immediately. In this state, the lamp 10 indicates that the semiconductor laser 101 is in the current decreased state.

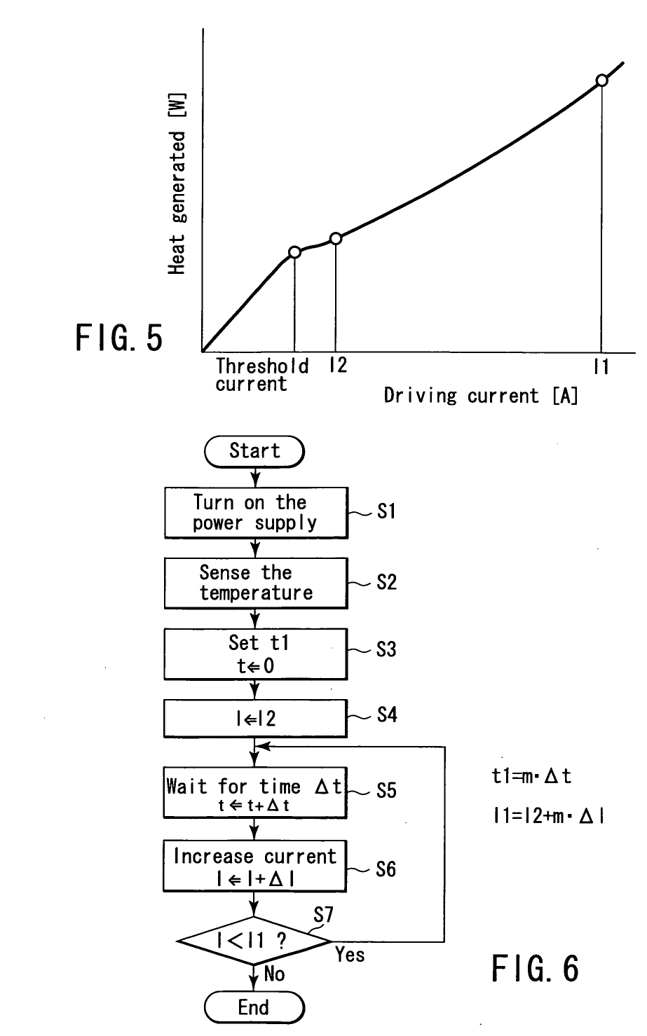

Next, the control circuit 106 calculates the shortest time t1 until the steady current value 11 is reached, from the sensed temperature T3 and operating temperature range upper limit T2 at the beginning, temperature T1 in the steady state, the heat absorbing capability of the driving circuit 105 and Peltier element 102, and the heat capacity and heat generating characteristic (FIG. 5) of the semiconductor laser 101. Then, the control circuit 106 controls the constant-current source 107 in such a manner that the driving current to the semiconductor laser 101 is increased gradually as time elapses. Therefore, as T3 is closer to T2, t1 becomes smaller, with the result that the time from the start-up until the steady state is shorten. Alternatively, t1 may be fixed, thereby making 12 larger.

Because of the operation of the driving circuit 105 and Peltier element 102, the sensed temperature drops gradually and becomes equal to or lower than the operating temperature range upper limit T2. Then, the control circuit 106 not only controls the constant-current source 107 after time t1 so as to cause steady current 11 to flow to the semiconductor laser 101 but also turns off the lamp 108.

FIG. 5 is a graph showing the relationship between the heat generated and the driving current in the semiconductor laser 101. As shown in FIG. 5, the amount of heat generated in the semiconductor laser generally increases monotonically as the driving current increases, after the threshold current is exceeded.

FIG. 6 is a flowchart to help explain the procedure for the operation of the laser light output apparatus of FIG. 3. In FIG. 6, when the power supply of the laser light output apparatus is turned on (step S1), the temperature sensing section 104 senses the temperature of the semiconductor laser 101 (step S2). According to the temperature sensed in step S2, the control circuit 106 sets t1 (step S3).

Next, the semiconductor laser 101 is first driven at the start current value 12 (step S4) and is caused to wait in this state for a very short time Δt (step S5). Thereafter, the control circuit 106 increases the driving current I of the semiconductor laser 101 gradually in increments of Δt (step S6). Then, this procedure is repeated until the driving current reaches the steady value I (a loop of step S7, step S5, and step S6). In this process, if time t1 elapsed until the steady current 11 is caused to flow is an m multiple of the very short time Δt (m is a positive integer), the steady current value I1 is obtained by adding the start current value I2 to the product of the current increment ΔI and m.

In the above process, when the power supply of the laser light output apparatus is off, that is, when the semiconductor laser 101 is not driven, the driving circuit 105 does not drive the Peltier element 102. As a result, the standby power needed for the operation of the Peltier element 102 is not consumed. Instead, in the standby state, the temperature of the semiconductor laser 101 varies according to the surroundings and is occasionally higher than the suitable operating temperature. In the first embodiment, the temperature sensing section 104 senses the temperature at the time when the driving of the semiconductor laser 101 is started. If the temperature of the semiconductor laser 101 is higher than the suitable operating temperature at that time, the driving of the semiconductor laser 101 is started with current 12 smaller than the steady current 11 and equal to or larger than the threshold current of the semiconductor laser 101. Then, in this state, not only is the driving current increased gradually to the steady current 11, but also time t1 elapsed until the steady current 11 is reached is minimized.

Accordingly, with the first embodiment, the standby power during the off state of the power supply is made unnecessary and light is outputted immediately after the turning on of the power supply, which minimizes the time elapsed until the steady optical output is reached. At a temperature equal to or higher than the operating temperature range upper limit, the driving current of the semiconductor laser 101 is reduced and the laser is caused to operate at an operating point lower than the full power. Therefore, no stress is applied to the semiconductor laser 101, which prevents the service life of the semiconductor laser 101 from being shortened. That is, the reduction of the consumption of the standby power is made compatible with the prevention of the shortening of the service life of the semiconductor laser. Furthermore, since the lamp 108 comes on when the apparatus is not in the full power operation, the user can recognize the operating state of the apparatus.

(Second Embodiment)

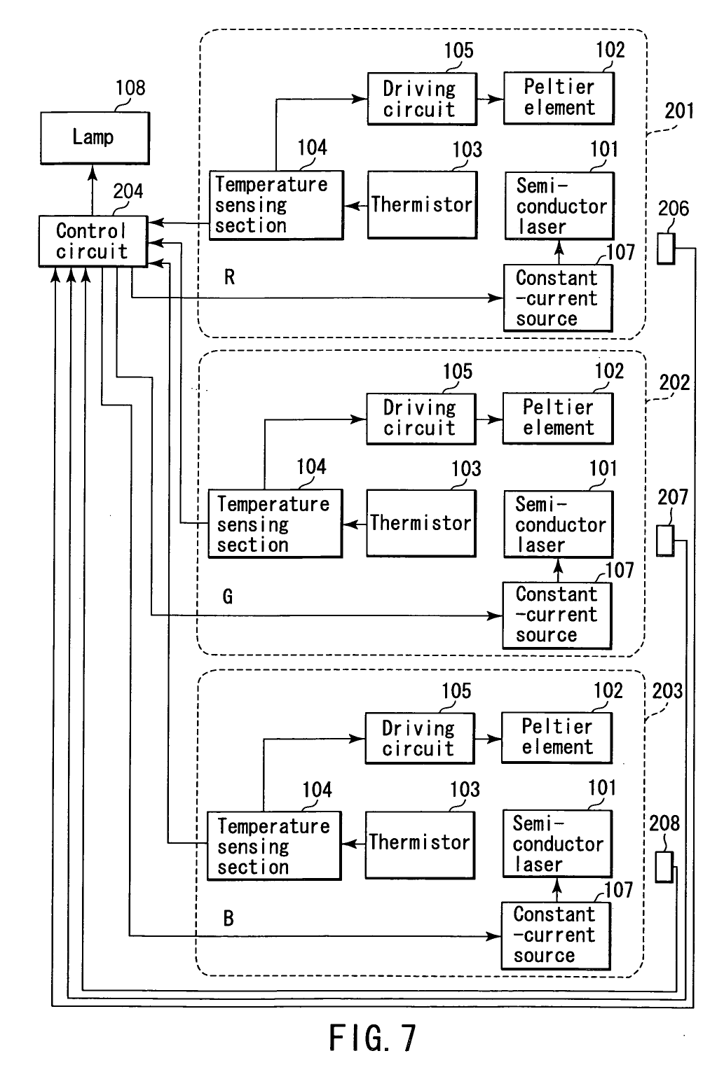

FIG. 7 is a functional block diagram of a second embodiment of a laser light output apparatus according to the present invention. In FIG. 7, the same parts as those in FIG. 3 are indicated by the same reference numerals. Only the parts differing from those in FIG. 3 will be explained.

The laser light output apparatus of FIG. 7 comprises a red semiconductor laser light source section 201, a green semiconductor laser light source section 202, and a blue semiconductor laser light source section 203. The red semiconductor laser light source section 201 is a system which eventually outputs red light. The green semiconductor laser light source section 202 is a system which eventually outputs green light. The blue semiconductor laser light source section 203 is a system which eventually outputs blue light. Each system of the semiconductor laser light source sections 201, 202, 203 have the same configuration as that of FIG. 3. A control circuit (indicated by numeral 204) is shared by the laser light source sections 201, 202, 203.

The temperature sensing section 104 of each of the semiconductor laser light source sections 201, 202, 203 supplies the sensed temperature to the corresponding control circuit 204. If the sensed temperature is equal to or higher than the operating temperature range upper limit T2, the control circuit 204 goes into the current reduction specified state for the corresponding system. When the control circuit 204 is not in the current reduction specified state for any of the semiconductor laser light source sections 201, 202, 203, it controls each of the constant-current sources 107. That is, the control circuit 204 causes steady driving currents I1R (for red), I1G (for green), I1B (for blue) to flow into the corresponding semiconductor lasers 101. The steady driving currents I1R, I1G, I1B are set according to the characteristics of the semiconductor lasers 101 for the respective colors and the final output characteristics of the respective colors passed through the optical system (not shown) in a subsequent stage. Hereinafter, the individual color systems are distinguished from one another by marking the reference numerals in FIG. 3 with R, G, and B.

On the other hand, suppose at least one of the systems of the semiconductor laser light source sections 201, 202, 203 is in the current reduction specified state. Then, the control section 204 controls the constant-current sources 107 in the semiconductor laser light source sections 201, 202, 203 of all the systems so that the driving currents of the semiconductor lasers 101 may be smaller than I1R, I1G, and I1B respectively and equal to or higher than the threshold value.

In FIG. 7, the power supply of the laser output apparatus is turned on, the thermistor 103, temperature sensing section 104, and driving circuit 105 for each color system start to operate. Explanation will be given on the assumption that only the temperature of the semiconductor laser 101 of the red system at this time is at an ambient temperature of T3 equal to or higher than the operating temperature upper limit T2. The temperature sensing section 104 of the red system supplies the sensed temperature to the control circuit 204.

Then, the control circuit 204 is in the current reduction specified state for the red system. In response to this, the control circuit 204 forces the driving current of the semiconductor laser 101 of each system to decrease, even if the temperature of the semiconductor laser 101 for each of the green system and blue system is equal to or lower than T2. That is, the control circuit 204 controls the constant-current source 107 of each system so as to cause 12R, 12G, and 12B smaller than the steady currents I1R, I1G, and I1B and equal to or larger than the threshold value to flow into the corresponding semiconductor lasers 101.

According to the characteristics of the semi-conductor lasers 101 for the respective color systems and the final output characteristics of the respective colors passed through the optical system (not shown) in a subsequent stage, I2R, I2G, and I2B are set so that the ratio of the optical output intensities of the respective colors may be kept constant. Therefore, immediately after the power supply is turned on, light is outputted and an image is displayed.

Furthermore, the control circuit 204 turns on the lamp 108 in this state, showing that it is in the current decreased state.

The final output light intensities of the semi-conductor laser light source sections 201, 202, 203 pass through the optical system (not shown) in a subsequent stage and are sensed by optical sensors 206, 207, 208, respectively. The sensed intensities are notified to the control circuit 204. The control circuit 204 controls each of the constant-current sources 107, drives the semiconductor laser 101 of each system with a current value that keeps constant the ratio of the respective color light output intensities according to the notified output light intensities, and increases the current gradually as time passes.

In this state, because of the operation of the driving circuit 105 and Peltier element 102, the sensed temperature drops gradually and the temperatures in all of the color systems become equal to or lower than the operating temperature range upper limit T2. Then, the current reduction specified state for the red system is cancelled, with the result that the semiconductor lasers 101 for the respective systems are driven with the steady current values I1R, I1G, and I1B respectively and the lamp 108 is turned off.

As described above, the second embodiment not only produces the effect of the first embodiment but also keeps constant the ratio of the light intensities of the respective colors. Therefore, in the light obtained by combining the output lights from the respective systems, the coordinates of each color on the chromaticity diagram can be kept constant. That is, a natural lighting operation can be realized. In the lighting operation, the luminance increases with the white color temperature kept constant, starting in the current decreased state, with the result that the steady value is reached. Therefore, the laser light output apparatus of the second embodiment can be used suitably as a light source for the three primary colors for a projection display as shown in FIG. 2.

The semiconductor laser 101 oscillating at wavelengths differing from those of the three primary colors may be used. To use this type of semiconductor laser, its output light wavelengths are converted into the wavelengths of the three primary colors by a wavelength-conversion fiber laser or the like.

(Third Embodiment)

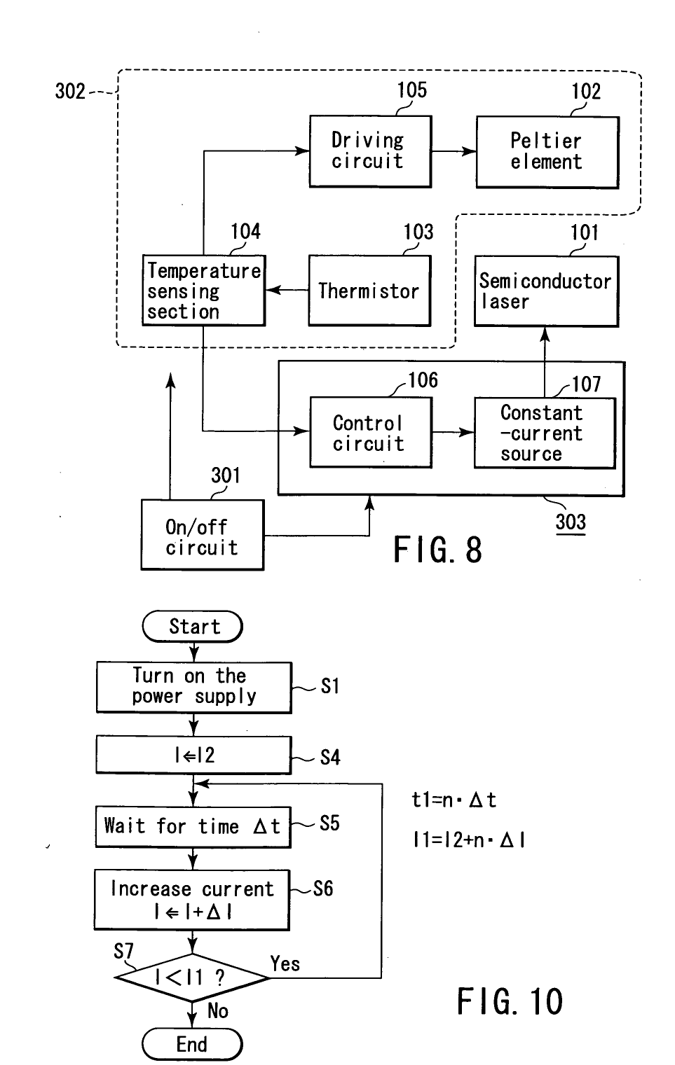

FIG. 8 is a functional block diagram of a third embodiment of a laser light output apparatus according to the present invention. In FIG. 8, the same parts as those in FIG. 3 are indicated by the same reference numerals. Only the parts differing from those in FIG. 3 will be explained. In FIG. 8, a set of the Peltier element 102, thermistor 103, temperature sensing section 104, and driving circuit 105 is referred to as a temperature control section 302. A set of the control circuit 106 and constant-current source 107 is referred to as a semiconductor laser driving section 303.

The laser light output apparatus of FIG. 8 includes an on/off circuit 301. The on/off circuit 301 performs on/off control of the operation of the temperature control section 302 and the operation of the semiconductor laser driving section 303 independently. At the time of the switching from off to on, the temperature control section 302 and semiconductor laser driving section 303 are turned on almost at the same time. In contrast, at the time of the switching from on to off, the temperature control section 302 is kept on until a specific duration time tc has elapsed since the semiconductor laser driving section 303 was turned on. After the duration time tc has elapsed, the temperature control section 302 is turned off.

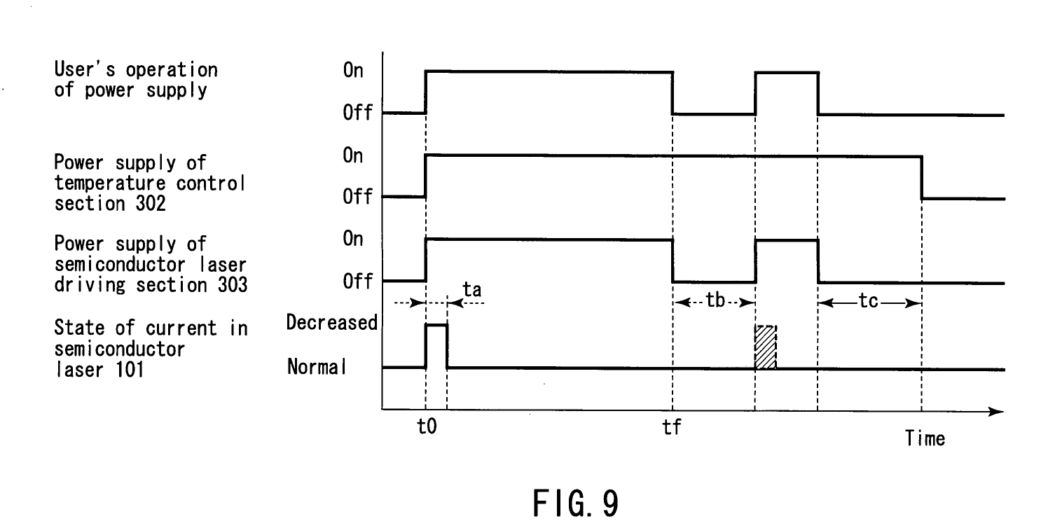

FIG. 9 is a timing chart to help explain the procedure for the operation of the laser light output apparatus of FIG. 8. In FIG. 9, too, the ambient temperature is equal to or higher than the semi-conductor laser operating temperature range upper limit.

In FIG. 9, when the power supply of the laser light output apparatus is turned on at time t0, the on/off circuit 301 turns on the temperature control section 302 and semiconductor laser driving section 303 almost at the same time. Then, the semiconductor laser 101 starts to operate in the current decreased state. After time ta has elapsed, the steady current 11 starts to flow into the semiconductor laser 101.

Thereafter, at time tf after a given time has elapsed, the laser light output apparatus is turned off. Suppose the power supply is turned on again after a relatively short time of tb shorter than the duration time tc. At the time that the power supply is turned on again, the temperature control section 302 is still in operation without being turned off during the period. As a result, the semiconductor laser 101 is kept at suitable temperature, with the result that the driving current value becomes steady value I1 at the time when the power supply is turned on again and therefore the semiconductor laser 101 is driven at full power when its operation is started again.

When the power supply off period tb is longer than the duration tc, the operation of the temperature control section 302 is also turned off. From this time on, the standby power necessary for temperature control is not needed at all.

As described above, since the operation of the temperature control section 302 is continued for the specific duration tc since the power supply was turned off, if the power supply is turned on again in a time shorter than tc, the semiconductor laser 101 can be operated at full power from the start. When the power supply is off for a time longer than the duration tc, the standby power can be made unnecessary.

The present invention is not limited to the above embodiments.

FIG. 10 is a flowchart to help explain another procedure for the operation of the laser light output apparatus of the invention. This flowchart is such that step S2 and step S3 are eliminated from the flowchart of FIG. 6. Specifically, in the procedure, the process of sensing the temperature of the semi-conductor laser 101 at the time when the power supply is turned on is removed. Then, the driving current at the time of start-up is forced to be a start current of 12, regardless of temperature (step S4). In addition, the time passed until the steady driving current is reached is represented by t1=n·Δt, equal to or longer than the shortest time calculated at the estimated highest ambient temperature and is fixed to this value, where n is a positive integer and Δt is a very short time. Thereafter, as in FIG. 6, the driving current I is increased in step S5 to step S7.

By the above procedure, full-power driving at high temperature can be avoided, although a part of the previous procedure is omitted. Therefore, as in the first embodiment, the shortening of the service life of the semiconductor laser 101 can be prevented. Since a part of the procedure has been omitted, the burden on the control circuit 106 is reduced, which produces the effect of reducing the manufacturing and operation costs.

To summarize what has been described above, with the present invention, the cooling elements, including the Peltier element, are basically turned off when the semiconductor laser is off. Therefore, the standby power is also unnecessary. When this state is continued, the temperature of the semiconductor laser rises gradually and reaches the ambient temperature. In this state, when the power supply is turned on and the driving of the semiconductor laser is started again, the initial driving current smaller than the steady value at a suitable operating temperature is injected into the semiconductor laser by the driving current control section. Then, as the semiconductor laser is cooled by the electronic temperature control section, the driving current is increased gradually and reaches the steady state according to the elapse of time. Therefore, the semiconductor laser is prevented from being driven with full-power current at high temperature, which prevents excessive stress from being applied to the semiconductor laser and therefore the service life from being shortened.

As described above in detail, it is possible to provide a laser light output apparatus, an image display apparatus, and a semiconductor laser driving control method which can make the reduction of the consumption of the standby power compatible with the prevention of the shortening of the service life of the semiconductor laser.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A laser light output apparatus comprising:
a semiconductor laser which has a suitable operating temperature;
a driving section which supplies a driving current to the semiconductor laser;
a temperature sensing section which senses the temperature of the semiconductor laser;
an electronic temperature control section which controls the temperature of the semiconductor laser to the suitable operating temperature on the basis of the temperature sensed by the temperature sensing section in a state where at least the semiconductor laser is being driven; and
a driving current control section which sets the driving current to an initial value smaller than a steady value at the suitable operating temperature at the start time of the driving of the semiconductor laser and changes the driving current to the steady value as the temperature of the semiconductor laser changes to the suitable operating temperature under the control of the electronic temperature control section.

2. A laser light output apparatus comprising:
a semiconductor laser which has a suitable operating temperature;
a driving section which supplies a driving current to the semiconductor laser;
a temperature sensing section which senses the temperature of the semiconductor laser;
an electronic temperature control section which controls the temperature of the semiconductor laser to the suitable operating temperature on the basis of the temperature sensed by the temperature sensing section in a state where at least the semiconductor laser is being driven; and
a driving current control section which sets the driving current to an initial value smaller than a steady value at the suitable operating temperature at the start time of the driving of the semiconductor laser and changes the driving current to the steady value as time elapses since the start time of the driving.

3. The laser light output apparatus according to claim 1, wherein the driving current control section determines the initial value according to the temperature sensed by the temperature sensing section at the start time of the driving of the semiconductor laser and changes the driving current according to the temperature sensed by the temperature sensing section.

4. The laser light output apparatus according to claim 1, wherein the initial value is a threshold current which causes the semiconductor laser to start laser oscillation.

5. The laser light output apparatus according to claim 2, wherein the initial value is a threshold current which causes the semiconductor laser to start laser oscillation.

6. The laser light output apparatus according to claim 1, further comprising:
a displaying section which, when the driving current is smaller than the steady value, displays the state.

7. The laser light output apparatus according to claim 2, further comprising:
a displaying section which, when the driving current is smaller than the steady value, displays the state.

8. The laser light output apparatus according to claim 1, further comprising:
a continuing section which, when the driving of the semiconductor laser is stopped, causes the electronic temperature control section to continue a temperature control operation for a specific duration since the stop time of the driving.

9. The laser light output apparatus according to claim 2, further comprising:
a continuing section which, when the driving of the semiconductor laser is stopped, causes the electronic temperature control section to continue a temperature control operation for a specific duration since the stop time of the driving.

10. An image display apparatus comprising:
a display section;
a light source section which generates and outputs a plurality of laser beams differing in wavelength; and
a projection section which processes each of said plurality of laser beams on the basis of a video signal and projects the resulting signal onto the display section, wherein
the light source section includes
a plurality of laser light output sections which generate and output the laser beams separately, and
a balance keeping section which maintains constant the intensity balance between the laser beams outputted from the laser light output sections, each of said plurality of laser light output sections including
a semiconductor laser which has a suitable operating temperature;
a driving section which supplies a driving current to the semiconductor laser;
a temperature sensing section which senses the temperature of the semiconductor laser;
an electronic temperature control section which controls the temperature of the semiconductor laser to the suitable operating temperature on the basis of the temperature sensed by the temperature sensing section in a state where at least the semiconductor laser is being driven; and
a driving current control section which sets the driving current to an initial value smaller than a steady value at the suitable operating temperature at the start time of the driving of the semiconductor laser and changes the driving current to the steady value as the temperature of the semiconductor laser changes to the suitable operating temperature under the control of the electronic temperature control section.

11. An image display apparatus comprising:
a display section;
a light source section which generates and outputs a plurality of laser beams differing in wavelength; and
a projection section which processes each of said plurality of laser beams on the basis of a video signal and projects the resulting signal onto the display section, wherein
the light source section includes
a plurality of laser light output sections which generate and output the laser beams separately, and
a balance keeping section which maintains constant the intensity balance between the laser beams outputted from the laser light output sections, each of said plurality of laser light output sections including
a semiconductor laser which has a suitable operating temperature;
a driving section which supplies a driving current to the semiconductor laser;
a temperature sensing section which senses the temperature of the semiconductor laser;
an electronic temperature control section which controls the temperature of the semiconductor laser to the suitable operating temperature on the basis of the temperature sensed by the temperature sensing section in a state where at least the semiconductor laser is being driven; and
a driving current control section which sets the driving current to an initial value smaller than a steady value at the suitable operating temperature at the start time of the driving of the semiconductor laser and changes the driving current to the steady value as time elapses since the start time of the driving.

12. The image display apparatus according to claim 10, wherein in each of said plurality of laser light output sections,
the driving current control section determines the initial value according to the temperature sensed by the temperature sensing section at the start time of the driving of the semiconductor laser and changes the driving current according to the temperature sensed by the temperature sensing section, and
the balance keeping section, when the driving current control section makes the driving current of the semiconductor laser lower than the steady value in at least one of said plurality of laser light output sections, forces the driving currents of the semiconductor lasers of all of the other laser light output sections to decrease.

13. The image display apparatus according to claim 10, wherein in each of said plurality of laser light output sections,
the initial value is a threshold current which causes the semiconductor laser to start laser oscillation.

14. The image display apparatus according to claim 11, wherein in each of said plurality of laser light output sections,
the initial value is a threshold current which causes the semiconductor laser to start laser oscillation.

15. A driving control method for a semiconductor laser with a suitable operating temperature, comprising:
a driving current setting step of setting a driving current for driving the semiconductor laser to an initial value smaller than a steady value at the suitable operating temperature at the start time of the driving of the semiconductor laser;
a temperature control step of controlling the temperature of the semiconductor laser to the suitable operating temperature; and
a driving current changing step of changing the driving current to the steady value as the temperature of the semiconductor laser changes to the suitable operating temperature in the temperature control step.

16. A driving control method for a semiconductor laser with a suitable operating temperature, comprising:
a driving current setting step of setting a driving current for driving the semiconductor laser to an initial value smaller than a steady value at the suitable operating temperature at the start time of the driving of the semiconductor laser; and
a driving current changing step of changing the driving current to the steady value as time elapses since the start time of the driving.

17. The driving method according to claim 15, further comprising a temperature sensing step of sensing the temperature of the semiconductor laser, wherein
the driving current setting step is a step of determining the initial value according to the temperature sensed in the temperature sensing step at the start time of the driving of the semiconductor laser, and
the driving current changing step is a step of changing the driving current according to the temperature sensed in the temperature sensing step.

18. The driving method according to claim 15, wherein the driving current setting step sets the initial value as a threshold current which causes the semiconductor laser to start laser oscillation.

19. The driving method according to claim 16, wherein the driving current setting step sets the initial value as a threshold current which causes the semiconductor laser to start laser oscillation.
